(19) United States
(12) Patent Application Publication
(10) Pub. No.: US 2007/0030159 A1
(43) Pub. Date: Feb. 8, 2007

(54) Method and apparatus for detecting free fall of mobile device and recording medium storing computer program for executing the method

(75) Inventors: Julian Stoev, Seoul (KR); Jun-seok Shim, Seongnam-si (KR); Haeng-soo Lee, Suwon-si (KR); Sang-eun Baek, Incheon-si (KR); Kyu-nam Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/192,422

(22) Filed: Jul. 29, 2005

(30) Foreign Application Priority Data
Jul. 23, 2005 (KR) 10-2005-0067058

(51) Int. Cl. G01P 15/00

(52) U.S. Cl. 340/669; 73/503

(57) ABSTRACT

A method, an apparatus and a computer readable recording medium storing a program for correctly detecting a free fall by referring to an acceleration and an integration of the acceleration. The method includes sensing an acceleration of the mobile device; integrating the sensed acceleration with respect to time; and determining the free fall by comparing the result of the integrating with a predetermined area threshold.

### CROSS-REFERENCE TO RELATED PATENT APPLICATIONS

This application claims priority from Korean Patent Application No. 10-2005-0067058, filed on Jul. 23, 2005 in the Korean Intellectual Property Office, the disclosure of which is incorporated herein in its entirety by reference.

### BACKGROUND OF THE INVENTION

1. Field of the Invention

Apparatuses and methods consistent with the present invention relate to detecting a free fall of a mobile device, and more particularly, to detecting a free fall of a mobile device by referring an acceleration and an integration of the acceleration.

2. Description of the Related Art

Mobile devices, such as mobile phones, personal digital assistants (PDAs), and digital cameras, household electronic devices, office electronic devices, etc. have become essential in daily life. These devices or storage devices therein, for example, a hard disk drive (HDD), need to be protected from a free fall shock.

For HDDs integrated into mobile devices, shock resistance is an important property. One way to improve shock resistance is to make a head of the hard disk drive retracted to a safe region by detecting a free fall of the mobile device.

In a conventional method, a free fall alarm to initiate a retraction of the head of the HDD is generated when an acceleration of the mobile device remains less than a threshold value for a predetermined time. Techniques for detecting a free fall of a mobile device to protect an HDD thereof are disclosed in Japanese Patent Publication Nos. 2005-91219 and 2003-34644, Korean Patent Publication No. 2005-17248, United States Patent Application Publication No. 2005/0099719, etc.

FIG. 1 illustrates the concept of protecting a mobile device 102 from a free fall shock. Assuming that a free fall detection and a head retraction takes 200 ms, this condition corresponds to the case with a protection height p=0.196 m and a velocity v=1.96 m/s. This means that the head retraction must be initiated at a time tₜₕ after the falling acceleration becomes less than the threshold aₜₕ as shown in the graph of FIG. 1. Here, tₜₕ is less than 200 ms.

The acceleration can be detected using a three-axis accelerometer 104 and an acceleration vector can be calculated as follows:
∥aμ=\sqrt{aₓ²+a_{y}²+a_{z}²}
where aₓ, a_{y} and a_{z} are acceleration values along x, y and z axes, respectively.

FIG. 2 illustrates a concept of detecting the free fall of a mobile device according to a conventional method. Referring to FIG. 2, in operation S202 an acceleration threshold aₜₕ and a time threshold tₜₕ are set.

In operation S204, an output of an acceleration sensor, for example an output of the accelerometer 104 shown in FIG. 1, is sampled.

In operation S206, an acceleration vector ∥a∥ is calculated.

In operation S208, it is checked whether the acceleration vector ∥a∥ is less than the acceleration threshold aₜₕ.

If the acceleration vector ∥a∥ is greater than the acceleration threshold aₜₕ, then the method returns to operation S204.

In operation S210, it is checked whether the acceleration vector ∥a∥ is constant, that is, whether the value of the acceleration vector ∥a∥ remains less than the acceleration threshold aₜₕ.

If it is determined that the acceleration vector ∥a∥ did not remain less than the acceleration threshold aₜₕ, then the method returns to operation S204.

If the acceleration vector ∥a∥ remains less than the acceleration threshold aₜₕ, then in operation S212 it is checked whether the time threshold tₜₕ has elapsed.

If the time threshold tₜₕ has not elapsed, then sampling of the acceleration sensor and calculation of the acceleration vector ∥a∥ are performed in sequence (S216 and S214) and then the method returns to operation S210.

If it is determined that the time threshold tₜₕ has elapsed, then a free fall alarm is generated. Accordingly, the head retraction unit (not shown) starts to retract a head to a safe region to protect data written on disks of an HDD.

As described above, whether the time threshold tₜₕ has elapsed is checked after the acceleration vector ∥a∥ becomes less than the acceleration threshold aₜₕ in the conventional method.

However, not all the motions of a mobile device that meets the conditions regarding the acceleration threshold aₜₕ and the time threshold tₜₕ are caused by a free fall of the mobile device. For example, instant falling accompanied to repetitive movements, such as working, running, dancing, pressing buttons, etc. and non-repetitive movements such as intentionally spinning or tossing the mobile device, pushing off a table whereon the mobile device is placed slowly, etc., should not be regarded as free falls.

FIGS. 3A through 3D illustrate outputs of acceleration sensors being worn at different bodily positions by a person running at a speed of 9.5 km/h. In each graph, the horizontal axis indicates sampling orders and the vertical axis indicates acceleration of gravity. Referring to FIGS. 3A through 3D, it can be seen that the value of total acceleration Gₜₒₜ sensed by the acceleration sensor differs according to the positions of the sensor for example, breast position, wrist position, pocket position, and waist position. Obviously, measures to protect from a free fall are not necessary when a person carrying the device is running. However in the conventional method there is a high possibility that a free fall alarm is generated, especially, when the device is attached to the wrist. To make matters worse, the false free fall alarm can be generated frequently and periodically. As a result, frequent retractions of a head of an HDD are caused and data written on disks of the HDD can be damaged thereby.

FIG. 4 illustrates a relation of elapsed time versus numbers of cases corresponding to the elapsed time according to different running speeds and different positions of the sensor. In FIG. 4, the horizontal axis indicates the experiment and the vertical axis indicates elapsed time when the acceleration remains less than 0.5 g. The experiments are ordered in the increasing speed of user movement, i.e., in the range from 0 km/h to 12 km/h. Referring FIG. 4, it can be seen that there are many critical cases when the acceleration remains less than 0.5 g for longer than 200 ms. Those cases do not need a free fall alarm. However, by the conventional method, a free fall alarm is generated in these critical cases unnecessarily.

FIG. 5 illustrates a particular case amongst critical cases, shown in FIG. 4, where false free fall alarms are generated by the conventional method. The case, shown in FIG. 5, does not need a free fall alarm even though the time when the acceleration remains less than 0.5 g is greater than 200 ms.

### SUMMARY OF THE INVENTION

The present invention provides a method of correctly detecting a free fall of a mobile device.

The present invention also provides an apparatus for correctly detecting a free fall of a mobile device. The present invention also provides a computer readable recording medium storing a program to execute the method.

According to an aspect of the present invention, there is provided a method of detecting a free fall of a mobile device, the method comprising: sensing an acceleration of the mobile device; integrating the sensed acceleration with respect to time; and determining the free fall by comparing the result of the integrating with a predetermined area threshold.

According to another aspect of the present invention, there is provided an apparatus for detecting a free fall of a mobile device according, the apparatus comprising: an acceleration sensor for sensing an acceleration of the mobile device; an integrating unit for integrating an output of the acceleration sensor; and an free fall determining unit for determining the free fall by comparing an output of the integrating unit with a predetermined area threshold.

According to another aspect of the present invention, there is provided a computer readable recording medium storing a program to execute a method of detecting a free fall of a mobile device, the method comprising: sensing an acceleration of the mobile device; integrating the sensed acceleration when the sensed acceleration is less than a predetermined acceleration threshold; comparing the result of integrating with a predetermined area threshold; and generating a free fall alarm when the result of the integrating is greater than a predetermined area threshold.

### BRIEF DESCRIPTION OF THE DRAWINGS

The above and/or other aspects of the invention will become more apparent and readily appreciated from the following description of the exemplary embodiments of the present invention, taken in conjunction with the accompanying drawings of which:

FIG. 1 illustrates the concept of protecting a mobile device 102 from a free fall shock.

FIG. 2 illustrates a concept of detecting the free fall of a mobile device according to a conventional method;

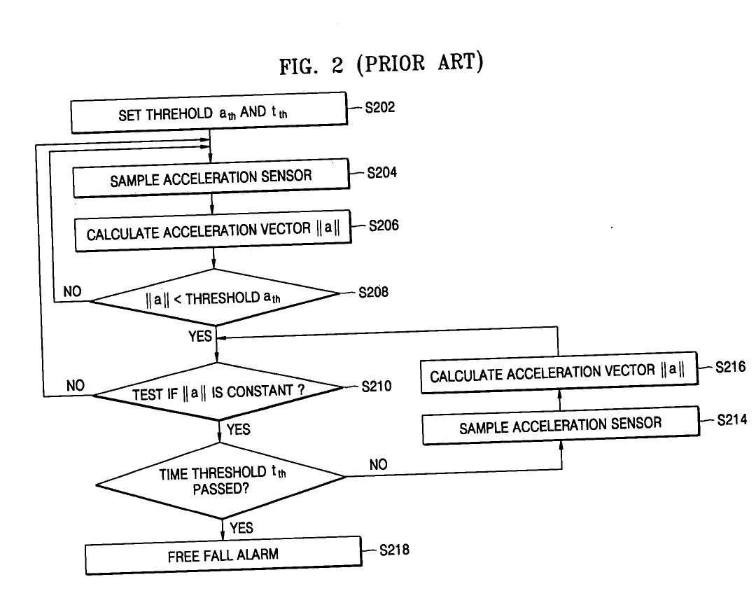

FIGS. 3A through 3D illustrate an output of an acceleration sensor being worn at different bodily positions by a person running at a speed of 9.5 Km/h;

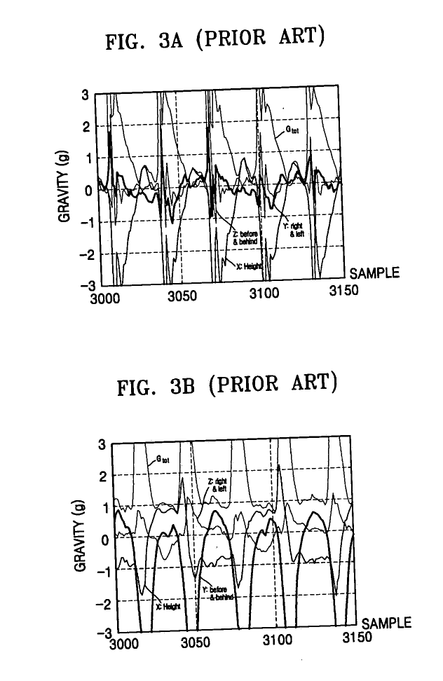

FIG. 4 illustrates a plot of elapsed time versus numbers of cases corresponding to the elapsed time according to different running speeds and different positions of the sensor;

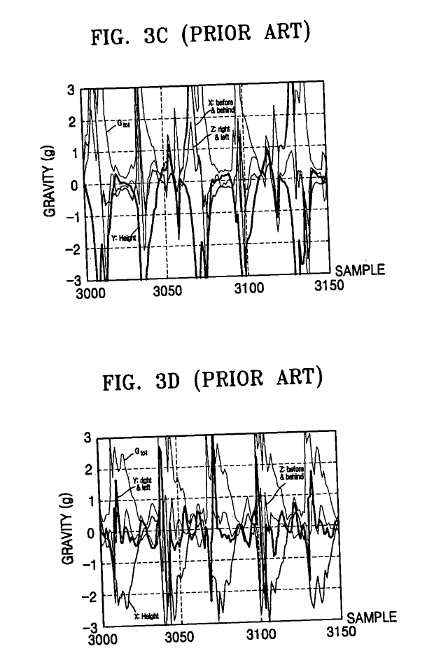

FIG. 5 illustrates a case of when a false free fall alarm is generated by the conventional method;

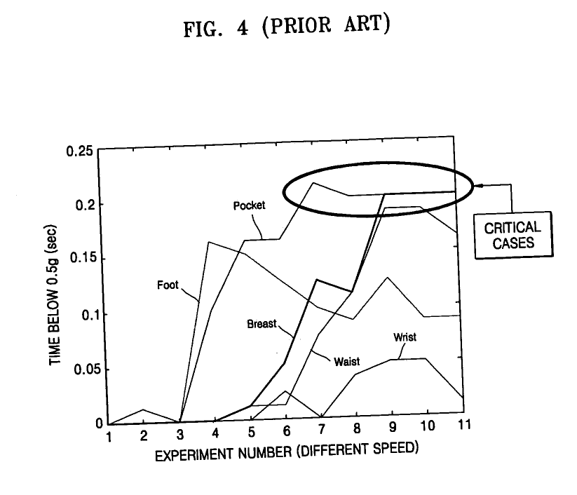

FIGS. 6A and 6B illustrate a concept of detecting a free fall of a mobile device according to the present invention;

FIG. 7 illustrates a method of detecting a free fall of a mobile device according to an exemplary embodiment of the present invention;

FIG. 8 illustrate another method of detecting a free fall of a mobile device according to another exemplary embodiment of the present invention.

FIG. 9 illustrates results of integrating in cases of a free fall situation and a non-free fall movement;

FIG. 10 illustrates another results of integrating in cases of a free fall situation and a non-free fall movement; and

FIG. 11 illustrates a free fall detecting apparatus according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

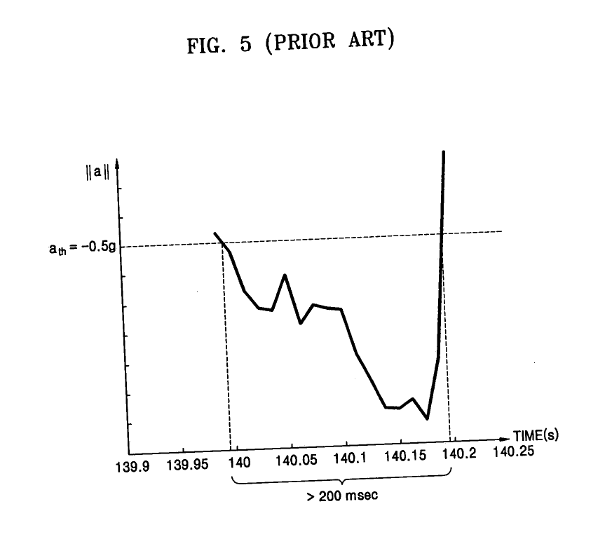

FIGS. 6A and 6B illustrate a concept of detecting a free fall of a mobile device according to the present invention. Both FIG. 6A and FIG. 6B correspond to the same situation when an acceleration is less than 0.5 g for 200 ms. The case shown in FIG. 6A corresponds to a non-free fall movement, for example, walking, running, dancing, toss and catch, etc., such that measures to protect a mobile device from a free fall shock are unnecessary. The case shown in FIG. 6B corresponds to a free fall of mobile device, such that measures to protect the mobile device from a free fall shock must be taken. Thus, there is a need to distinguish the two cases from each other. As can be seen from FIGS. 6A and 6B, volumes of areas below 0.5 g are different from each other. Accordingly, the two cases can be distinguished from each other by integrating the acceleration vectors and comparing the integration results with a predetermined threshold value.

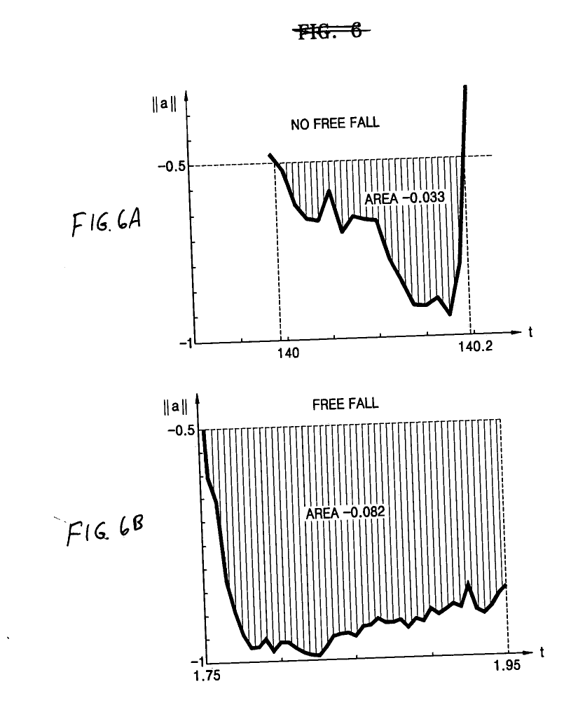

FIG. 7 illustrates a method of detecting a free fall of a mobile device according to an exemplary embodiment of the present invention. Referring to FIG. 7, in operation S702, an acceleration threshold aₜₕ, an area threshold vₜₕ and a time threshold tₜₕ are set.

Here the acceleration threshold aₜₕ, the area threshold vₜₕ and the time threshold tₜₕ are dependent on the characteristics of an acceleration sensor and a head retraction unit (not shown).

In operation S704, a temporary variable vₖ is initialized to 0. The temporary variable vₖ is for storing a integration results.

In operation S706, an acceleration of the mobile device is detected, and then an acceleration vector ∥a∥ is calculated. In the exemplary embodiment of the present invention, the acceleration vector ∥a∥ can be calculated by either a square root operation or a simple summation of an acceleration sensed by the acceleration sensor.

In operation S708, it is checked whether the acceleration vector ∥a∥ is less than the acceleration threshold aₜₕ. If it is determined that the acceleration vector ∥a∥ is not less than the acceleration threshold aₜₕ, then the method returns to operation S704.

If it is determined that the acceleration vector ∥a∥ is less than the acceleration threshold aₜₕ, then, in operation S710, the acceleration vector ∥a∥ is integrated to obtain a temporary variable of vₖ₊₁, here k notifies an sequence number of integration operation.

In operation S712, it is checked whether the time threshold tₜₕ has elapsed.

If it determined that the time threshold tₜₕ has not elapsed, then the method returns to operation S706.

If it determined that the time threshold tₜₕ has elapsed, then, in operation S714, it is checked whether the temporary variable vₖ₊₁ is greater than the area threshold vₜₕ.

If it is determined that the temporary variable vₖ₊₁ is not greater than the area threshold vₜₕ, the method returns to operation S704.

If it is determined that the temporary variable vₖ₊₁ is greater than the area threshold vₜₕ, then in operation S720 a free fall alarm is generated.

Although it is checked whether the acceleration vector ∥a∥ is less than the acceleration threshold aₜₕ according to the exemplary embodiment of the present invention shown in FIG. 7, the present invention is not limited to this exemplary embodiment.

Although it is checked whether the time threshold tₜₕ has elapsed according to the exemplary embodiment of the present invention shown in FIG. 7, the present invention is not limited to this exemplary embodiment. However, the integration value could be set to initiate if the acceleration ∥a∥ is greater than the predetermined acceleration threshold aₜₕ after starting integration of the acceleration ∥a∥.

According to the present invention, operation S708 and S712 can be omitted. In this case, in the operation S710, n samples are integrated, here n denotes sampling numbers corresponding to the predetermined time threshold tₜₕ. That is, the integration value integrated for the predetermined time threshold tₜₕ is compared with the predetermined area threshold each time the operation S714 is performed. In this case, the integration value also could be set to initiate when the acceleration is greater than the predetermined acceleration threshold aₜₕ.

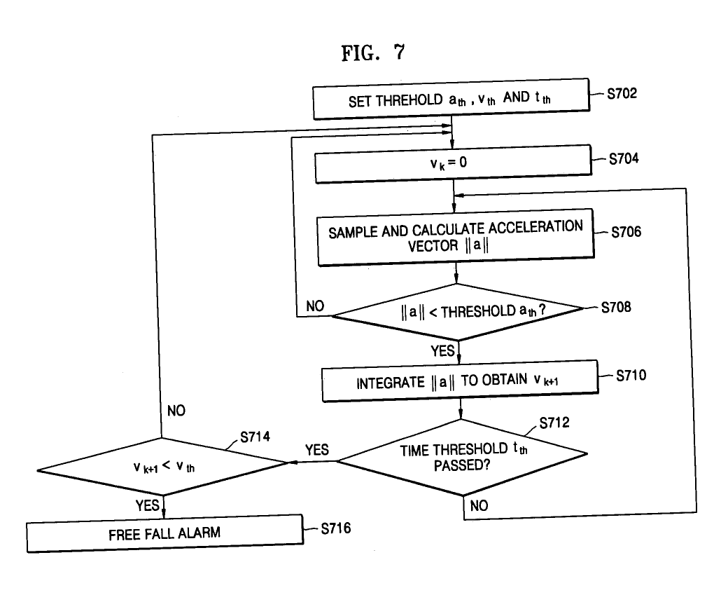

FIG. 8 illustrate another method of detecting a free fall of a mobile device according to another exemplary embodiment of the present invention. Referring to FIG. 8, in operation S802, an acceleration threshold aₜₕ, an area threshold vₜₕ and a time threshold tₜₕ are set.

In operation S804, a temporary variable vₖ is initialized to 0. The temporary variable vₖ is for storing a integration results.

In operation S806, an acceleration of the mobile device is detected, and then an acceleration vector ∥a∥ is calculated.

In operation S808, it is checked whether the acceleration vector ∥a∥ is less than the acceleration threshold aₜₕ. If it is determined that the acceleration vector ∥a∥ is not less than the acceleration threshold aₜₕ, then the method returns to operation S804.

If it is determined that the acceleration vector ∥a∥ is less than the acceleration threshold aₜₕ, then, in operation S810, the acceleration vector ∥a∥ is integrated to obtain a temporary variable of vₖ₊₁, here k notifies an sequence number of integration operation.

In operation S814, it is checked whether the temporary variable vₖ₊₁ is greater than the area threshold vₜₕ.

If it is determined that the temporary variable vₖ₊₁ is not greater than the area threshold vₜₕ, the method returns to operation S806.

If it is determined that the temporary variable vₖ₊₁ is greater than the area threshold vₜₕ, then in operation S816 the motion is classified as a free fall.

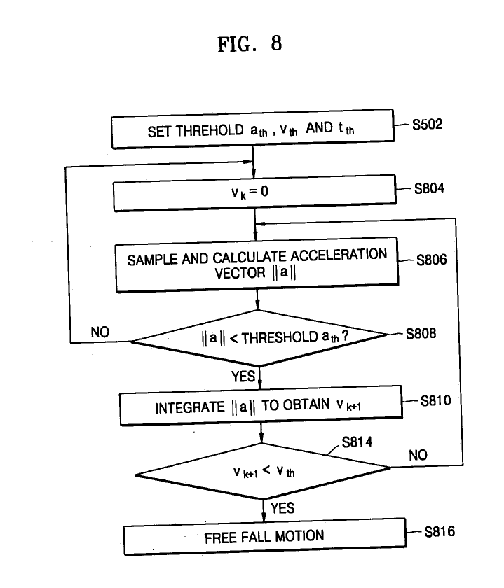

FIG. 9 illustrates results of integrating in cases of a free fall situation and a non-free fall movement. Here, the acceleration vector is calculated by a square root operation.

As shown by the circled numbers in FIG. [8]9, the results of integration for the free fall situation and the results for the non-free fall movement are quite different from each other.

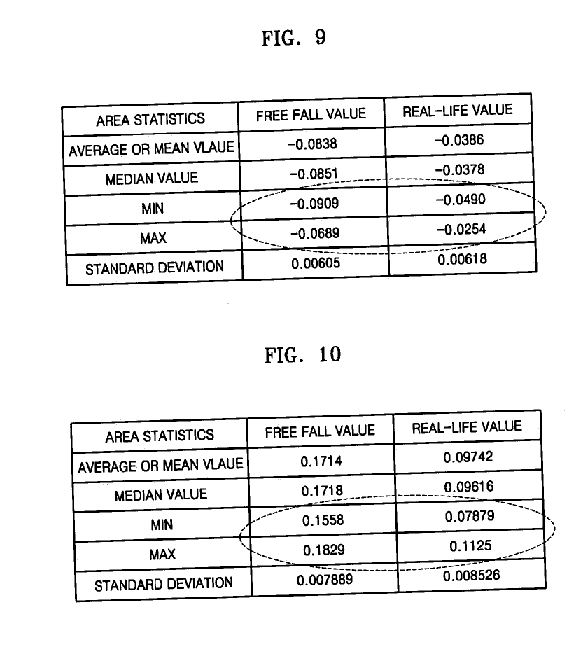

FIG. 10 illustrates other results of integrating in cases of a free fall situation and a non-free fall movement. Here, the acceleration vector is calculated by a simple summation.

As well as in FIG. 9, the results of integrating in other cases of a free fall situation and a non-free fall movement respectively shown by a circled numbers in FIG. 10 are quite different from each other.

The use of the simple summation to obtain the acceleration vector is very helpful because a square root function is computationally expensive even though it can be implemented with a C program language.

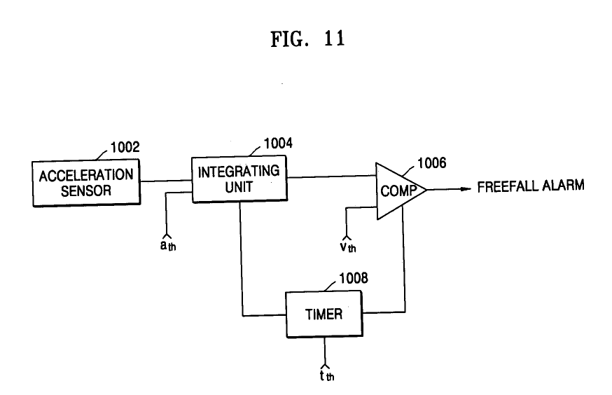

FIG. 11 illustrates a free fall detecting apparatus of a mobile device according to an exemplary embodiment of the present invention, which comprises an integrating unit 1004 and a comparing unit 1006.

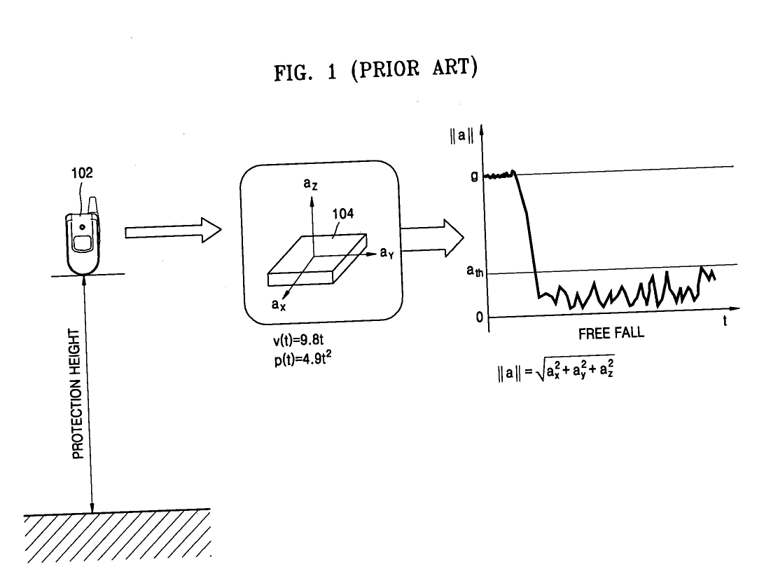

An acceleration sensor 1002 senses an acceleration of a mobile device. The acceleration sensor 1002 is, for example, a three-axis acceleration sensor as shown FIG. 1, and the mobile device has an HDD, which must be protected from a free fall shock.

The integrating unit 1004 starts to integrate an acceleration detected by the acceleration sensor 1002 when the acceleration is less than a predetermined acceleration threshold aₜₕ.

The comparing unit 1006 compares an output of the integrating unit 1004 with a predetermined area threshold vₜₕ and generates a free fall alarm when the output of the integrating unit 1004 is greater than the predetermined area threshold vₜₕ.

A timer 1006 counts time elapsed after the integrating unit 1004 started an integration operation and compares the result of counting with the time threshold tₜₕ in order to make the comparing unit 1006 start operating.

Since the integrating unit 1004 starts an integrating operation when the acceleration is less than a predetermined acceleration threshold aₜₕ, for example, 0.5 g, and the comparing unit 1006 compares the result of integration with an area threshold vₜₕ after a predetermined time threshold tₜₕ has elapsed, the apparatus of FIG. 11 does not generate a free fall alarm as long as the result of integration does not is greater than the predetermined area threshold vₜₕ. Thus, a false free fall alarm is not generated for non-free fall movements such as working, running, dancing, etc.

The apparatus shown in FIG. 11 can be implemented by a microprocessor installed in an HDD.

According to the present invention, because a free fall detection is performed according to both the acceleration and the integration of the acceleration, it is possible to avoid generating false free fall alarms for a non-free fall movements of a mobile device.

Thus, it is possible to effectively protect data written on a disk of an HDD installed in a mobile device from a non-free fall movements of a mobile device.

Exemplary embodiments of the present invention can be embodied as a method, an apparatus, or a system. When embodied as computer readable code/instructions, e.g., software, the present invention may be implemented by code-segments, for example. Programs and/or the code segments may be stored in a medium, e.g., a computer-readable recording medium, and/or may be transmitted through a transmission medium and/or over a communications network as computer data signals associated with carrier waves. Examples of the medium may include nearly all kinds of media for storing and/or transmitting data. For example, examples of the medium can include at least an electronic circuit, a semiconductor memory device, a ROM, a flash memory, an erasable ROM, a floppy disk, an optical disk, a hard disk, an optical fiber medium, and a radio frequency (RF) network, etc. Examples of computer data signals include nearly all types of signals that are storable and/or transmittable on such a storage/transmission medium as an electronic network channel, an optical fiber, air, an electromagnetic system, and an RF network, for example.

It should be appreciated that exemplary embodiments of the present invention can be applied not only to protect HDDs installed in a mobile device but also to protect other types of data storage devices and/or mobile device itself.

Even thought the present invention has been particularly shown and described with reference to exemplary embodiments thereof, it will be understood by those skilled in the art that various changes in form and details may be made therein without departing from the spirit and scope of the invention, scopes of claims defined in the appended claims and their equivalents.

What is claimed is:

1. A method of detecting a free fall of a device, the method comprising:
sensing an acceleration of the device;
integrating a sensed acceleration with respect to time; and
detecting the free fall by comparing a result of the integrating with a predetermined area threshold.

2. The method of claim 1, wherein the integrating the sensed acceleration is performed if the sensed acceleration is less than a predetermined acceleration threshold.

3. The method of claim 2, wherein the integrating the sensed acceleration is initiated if the sensed acceleration is greater than a predetermined acceleration threshold.

4. The method of claim 1, wherein the detecting the free fall further comprising generating a free fall alarm if the result of the integrating is greater than a predetermined area threshold.

5. The method of claim 4, wherein the detecting the free fall comprises comparing the result of the integrating for a predetermined time threshold with a predetermined area threshold.

6. The method of claim 1, wherein the sensed acceleration is an acceleration vector obtained by performing a square root operation on the acceleration.

7. An apparatus for detecting a free fall of a device, the apparatus comprising:
an acceleration sensor which senses an acceleration of the device;
an integrating unit which integrates the acceleration sensed by the acceleration sensor; and
an free fall detecting unit which detects the free fall by comparing an output of the integrating unit with a predetermined area threshold;

8. The apparatus of claim 7, wherein the integrating unit starts to integrate the output of the acceleration sensor if the acceleration is less than a predetermined acceleration threshold.

9. The method of claim 8, wherein the integrating unit is initiated to integrate the output of the acceleration sensor if the acceleration is greater than a predetermined acceleration threshold.

10. The apparatus of claim 7, wherein the free fall detecting unit begins to detect the free fall if a predetermined time threshold has elapsed after the integrating unit started integrating the acceleration.

11. The apparatus of claim 7, wherein the integrating unit integrates an acceleration vector obtained by performing a square root operation on the acceleration.

12. A computer readable recording medium storing a program to execute a method of detecting a free fall of a device, the method comprising:
sensing an acceleration of the device;
integrating a sensed acceleration if the sensed acceleration is less than a predetermined acceleration threshold;
comparing a result of the integrating with a predetermined area threshold; and
generating a free fall alarm based on a result of the comparing.
